(19) United States
(12) Patent Application Publication
(10) Pub. No.: US 2003/0019137 A1
(43) Pub. Date: Jan. 30, 2003

(54) Universal information tab for a garment hanger

(76) Inventors: Robert R. Giustini, Terrebonne (CA); Koen De Winter, Montreal (CA)

Correspondence Address: ROBIC, 55 St. Jacques, Montreal, QC, H2Y 3X2, CA

(21) Appl. No.: 10/247,908

(22) Filed: Sep. 20, 2002

Related U.S. Application Data
(63) Continuation of application No. 09/691,709, filed on Oct. 18, 2000, now abandoned.

(51) Int. Cl. G09F 3/00

(52) U.S. Cl. 40/322

(57) ABSTRACT

A universal information tab for a garment hanger. The universal information tab having a U-shaped bracket. The U-shaped bracket having two legs extending substantially parallel to each other. The two legs are connected to a bridge. The U-shaped bracket defining an inner surface. The inner surface having an integrally formed flange projecting perpendicularly inwardly from the inner surface and an integrally formed gripper at a second end of each leg for preventing the information tab from slipping off the hanger.

### FIELD OF THE INVENTION

The present invention broadly relates to garment hangers. More specifically, the invention relates to a universal information tab for a garment hanger.

### BACKGROUND OF THE INVENTION

It is desirable to provide a plastic garment hanger that can show information about the merchandise on display. Several types of garment hangers having an information tab on the base of the hook connecting it to the body of the hanger, are known. For instance, they are often used for displaying children clothes. The information tab used on each of these hangers are often times irremovable. For the ones that are removable, they are usually adapted to be used specifically with one type of hanger.

U.S. Pat. No. 5,611,469 is concerned with an identification clip adapted to be secured on a garment hanger. The identification clip according to the invention is not manually removable. Furthermore, it is made to fit the clip holder of the garment.

U.S. Pat. No. 5,199,608 is concerned with an identification tab that is irremovably secured to a garment hanger. The purpose of providing such tab is to prevent accidental removal of the tab from the garment hanger, once it is mounted on the latter by a store clerk.

U.S. Pat. No. 4,115,940 is concerned with a removable and changeable tab for a garment hanger. The tab is simple in structure in that it is moulded in one piece. However, it does not seem to be designed to fit a wide range of tab holders.

### SUMMARY OF THE INVENTION

It is an object of the present invention to provide a universal information tab for a garment hanger.

It is another object of the invention to provide an information tab that is easily mounted on any garment hanger.

It is a further object of the invention to provide a strong yet resilient and flexible information tab that will facilitate the installation of the information tab on the tab holder of the hanger.

More specifically, in accordance with the present invention, these objects are achieved with a universal information tab adapted to be fixed on a tab holder of a garment hanger. The information tab comprises a U-shaped bracket including two legs extending generally parallel to each other. The two legs each have a first and second end. The first end is connected to a bridge. The bridge forms a closed end of the bracket. The U-shaped bracket defines an inner surface adapted to be removably secured on the tab holder of the garment hanger. Each of said leg comprises at the inner surface:

an integrally formed flange projecting perpendicularly inwardly from the inner surface of the bracket, the flange being formed at a distance D1 from the first end of the leg each of the flanges having an end, the width between each end being W1, and

an integrally formed gripper at the second end of each leg for preventing the tab holder from slipping off the hanger.

An advantage provided by the information tab of the invention is its versatility to fit on a wide variety of hangers without regard to the physical characteristics of the body, or hook portions of the hangers.

Another advantage provided by such information tab is the fact that it is easily removable and thus may be reused.

### BRIEF DESCRIPTION OF THE DRAWINGS

FIG. 1 is a perspective side view of the information tab according to a preferred embodiment of the present invention, that is ready to be slid in a corresponding portion of the hanger.

FIGS. 2 to 4 are a cross sectional views of the information tab of FIG. 1 mounted on different prior art tab holders.

### DETAILED DESCRIPTION OF THE INVENTION

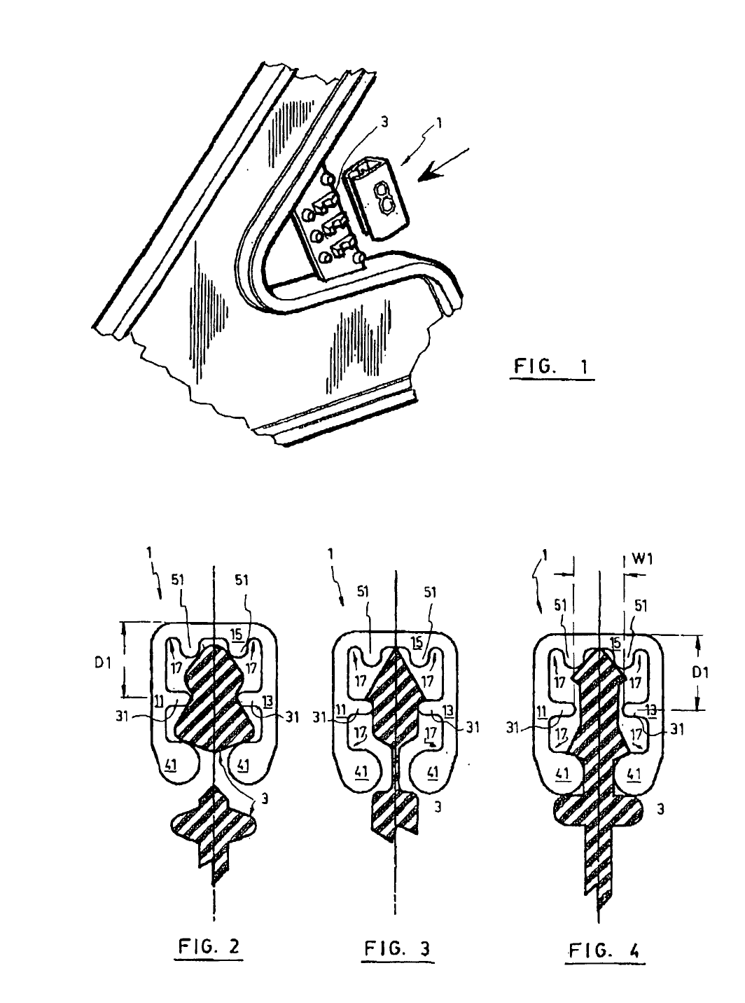

As can be seen in FIG. 1, the universal tab 1 of the present invention is adapted to be secured on a tab holder 3 on a garment hanger. The information tab 1 is clipped on the tab holder 3 in a conventional manner.

Referring now to FIGS. 2 to 4, the information tab 1 comprises a U-shaped bracket which includes two legs 11,13 extending substantially parallel to each other. The two legs 11,13 are connected at one end to a bridge 15 which extend perpendicularly with respect to the legs. The U-shaped bracket defines an inner surface 17 which is adapted to be removably secured on the tab holder 3 of the garment hanger.

The inner surface 17 of the information tab 1 of the invention comprises an integrally formed flange 31 projecting perpendicularly inwardly from each leg. The flange 31 is formed at a distance D1 from the first end of the leg. The distance D1 corresponds to a predetermined point along the leg. Preferably, D1 is calculated to be approximately at the middle point of each leg. Each flange is located on the leg so that they face each other and are separated by an open space having a width W1 between the facing extremities of each flange.

As further shown in FIGS. 2 to 4, the inner surface 17 of the universal information tab 1 of the invention also comprises an integrally formed gripper 41 at the second end of each leg for preventing the tab holder 3 from slipping off the hanger. In the illustrated embodiment, the gripper 41 comprises a longitudinal rib which extends inwardly from the inner surface 17 so that it is able to grip and hold the tab holder 3.

Preferably, the legs 11, 13 taper inwardly from the bridge 15 in order to enable the information tab 1 to be more strongly secured to the tab holder 3. In order to render this feature even more efficient, the information tab 1 may be made of a resilient moulded material or any suitable material, preferably PVC or polystyrene.

Still shown in FIGS. 2 to 4, the information tab 1 may further comprise an integrally formed set of grooves 51 projecting outwardly from the inner surface 17 of the bridge 15. The groove 51 is designed to fit a corresponding extremity of the tab holder 3.

The information tab 1 is shaped to accommodate practically any existing tab holder 3. Indeed FIGS. 2 to 4 show different types of existing tab holders while the sizer of the present invention is placed.

As can be seen more precisely in FIG. 2, the information tab of the present invention is able to receive and be secured on a pear-shaped prior art tab holder. The tab holder comprises an upper and a lower portions. The information tab is designed to receive and guide an extremity of the upper portion through the set of grooves 51 located in the inner surface 17 of the bridge 15. The protruding flanges 31 located in the inner surface of the legs 11, 13 are adapted to grip the area of the tab holder separating the upper portion from the lower portion. The flanges 17 play a crucial role in that by gripping the area between the upper and lower portions, it prevents the information tab to slip out from the tab holder. This is possible since most of the existing (prior art) tab holder are fashioned in such a way as to have an upper and bottom portions that are separated by a thinner “middle” area. Therefor, the upper and lower portions work as a blocking means. The grippers 41 located on the second end of each leg is designed to grip a corresponding end of the lower portion.

Turning now to FIG. 3, the prior art tab holder has a shape of an arrow. The arrow comprises a point portion which is slid in the guides 51 provided in the inner surface 17 of the bridge 15. The arrow further comprises a shaft portion. The flanges 31 of the information tab is designed to grip the arrow at the junction where the point is connected to the shaft. In the illustrated embodiment, the prior art tab holder comprises a thin portion at the end of the shaft. The grippers 41 are adapted to grip the thin portion of the arrow thereby temporarily locking the information tab on the tab holder.

In FIG. 4, the tab holder has the general shape of a double arrow. The two points being separated by a shaft portion. As seen in FIG. 3, the point of the upper arrow is secured in the guides 51 provided in the inner surface 17 of the bridge 15. The flanges 31 and the grippers 41 of the information tab are designed to grip the tab holder through corresponding shaft portions.

As can be seen, the information tab of the invention is advantageously designed to fit any existing tab holder. Furthermore it is also advantageously designed to be removable so that it may be easily reused on another hanger when the first is disposed of.

Although the present invention has been explained hereinabove by way of a preferred embodiment thereof, it should be pointed out that any modifications to this preferred embodiment within the scope of the present description is not deemed to alter or change the nature and scope of the invention.

1. A universal information tab adapted to be fixed on a tab holder of a garment hanger, the information tab comprising a U-shaped bracket including two legs extending generally parallel to each other, the two legs each having a first and second end, the first end being connected to a bridge, the bridge forming a closed end of the bracket, said U-shaped bracket defining an inner surface adapted to be removably secured on the tab holder of the garment hanger, each of said leg comprising at the inner surface:
an integrally formed flange projecting perpendicularly inwardly from the inner surface of the bracket, the flange being formed at a distance D1 from the first end of the leg each of the flanges having an end, the width between each end being W1, and
an integrally formed gripper at the second end of each leg for preventing the information tab from slipping off the hanger.

2. A universal information tab according to claim 1, wherein said legs taper inwardly from the bridge, said legs being further resiliently spreadable.

3. A universal information tab according to claim 2, wherein each of said gripper comprise a longitudinal rib extending inwardly from the inner surface, adapted to grip and hold the tab holder.

4. A universal information tab according to claim 3, wherein said universal information tab is made in a resilient molded material.

5. A universal information tab according to claim 1 further comprising an integrally formed set of grooves projecting outwardly from the inner surface of the bridge, the groove being designed to fit a corresponding extremity of the tab holder.

6 A universal information tab adapted to be fixed on a tab holder of a garment hanger, the information tab comprising a U-shaped bracket including two legs extending generally parallel to each other, the two legs each having a first and second end, the first end being connected to a bridge, the bridge forming a closed end of the bracket, the legs tapering inwardly from the bridge , said U-shaped bracket defining an inner surface adapted to be removably secured on the tab holder of the garment hanger, each of said leg comprising at the inner surface:
an integrally formed flange projecting perpendicularly inwardly from the inner surface of the bracket, the flange being formed at a distance D1 from the first end of the leg each of the flanges having an end, the width between each end being W1,
an integrally formed gripper at the second end of each leg for preventing the tab holder from slipping off the hanger, the gripper comprising a longitudinal rib extending inwardly from the inner surface and adapted to grip and hold the tab holder, and
an integrally formed set of grooves projecting outwardly from the inner surface of the bridge, the groove being designed to fit a corresponding extremity of the tab holder,
said information tab is made of a resilient molded material.
